(19) United States
(12) Patent Application Publication
(10) Pub. No.: US 2025/0273164 A1
(43) Pub. Date: Aug. 28, 2025

(54) DRIVING CIRCUIT

(71) Applicant: Samsung Display Co., LTD., Yongin-si (KR)

(72) Inventors: Keukjin JEONG, Yongin-si (KR); Min KANG, Yongin-si (KR); Wongyun KIM, Yongin-si (KR)

(21) Appl. No.: 19/021,661

(22) Filed: Jan. 15, 2025

(30) Foreign Application Priority Data
Feb. 27, 2024 (KR) 10-2024-0028154

(51) Int. Cl. G09G 3/3266

(52) U.S. Cl. CPC G09G 3/3266; G09G 2310/0286; G09G 2310/08

(57) ABSTRACT

A driving circuit includes stages. Each of stages includes a first transistor connected between a first node and a first terminal, and including a gate connected to a first clock terminal to which a first clock signal is input, a second transistor connected between the first and second nodes and including a gate connected to the first clock terminal, a third transistor connected between the first node and a second clock terminal to which a second clock signal is input, and including a gate connected to the first node, a first capacitor connected between the third transistor and the first node, a fourth transistor connected between output and second terminals to which a first voltage is applied, and including a gate connected to the first clock terminal, and a fifth transistor connected between the output terminal and the second clock terminal and including a gate connected to the second node.

This application claims priority to Korean Patent Application No. 10-2024-0028154, filed on Feb. 27, 2024, and all the benefits accruing therefrom under 35 U.S.C. § 119, the content of which in its entirety is herein incorporated by reference.

### BACKGROUND

### 1. Field

Embodiments relate to a display device, and more particularly, to a driving circuit that outputs a gate signal and a display device including the driving circuit.

### 2. Description of the Related Art

A display device includes a pixel area including a plurality of pixels, a gate driving circuit, a data driving circuit, a controller, and the like. The gate driving circuit includes stages connected to gate lines, and the stages apply gate signals through gate lines connected thereto in response to signals from the controller.

### SUMMARY

Embodiments include a driving circuit, which may stably output a gate signal with a relatively small size, and a display device including the driving circuit. The technical features to be achieved by the disclosure are not limited to the above-described features, and other technical features that are not mentioned herein would be clearly understood by a person skilled in the art from the description of the invention.

Additional features will be set forth in part in the description which follows and, in part, will be apparent from the description, or may be learned by practice of the presented embodiments of the disclosure.

In an embodiment of the disclosure, a driving circuit includes a plurality of stages, wherein each of the plurality of stages may include a first transistor connected between a first node and a first terminal to which a start signal is input, and including a gate connected to a first clock terminal to which a first clock signal is input, a second transistor connected between the first node and a second node and including a gate connected to the first clock terminal, a third transistor connected between the first node and a second clock terminal to which a second clock signal is input, and including a gate connected to the first node, a first capacitor connected between the third transistor and the first node, a fourth transistor connected between an output terminal and a second terminal to which a first voltage is applied, and including a gate connected to the first clock terminal, and a fifth transistor connected between the output terminal and the second clock terminal and including a gate connected to the second node.

In an embodiment, the start signal may include an external signal or an output signal output by a previous stage of each of the plurality of stages.

In an embodiment, each of the plurality of stages may further include a second capacitor connected between the second node and a third terminal to which a second voltage that is lower than the first voltage is applied, and a third capacitor connected between the second node and the output terminal.

In an embodiment, the first clock signal and the second clock signal may alternately repeat a first voltage level of the first voltage and a second voltage level of the second voltage, and the second clock signal is input by being shifted a ½ cycle from the first clock signal.

In an embodiment, in a first section, in which the start signal of the second voltage level is input, the first clock signal of the second voltage level is input, and the second clock signal of the first voltage level is input, a voltage of the first node and a voltage of the second node may be maintained at the second voltage level, and an output signal of the first voltage level may be output from the output terminal by the fourth transistor that is turned on and the fifth transistor that is turned on.

In an embodiment, in a second section subsequent to the first section, and in which the start signal of the first voltage level is input, the first clock signal of the first voltage level is input, and the second clock signal of the first voltage level is input, a voltage of the first node and a voltage of the second node may be maintained at the second voltage level, and the output signal of the first voltage level may be output from the output terminal by the fifth transistor that is turned on.

In an embodiment, in a third section subsequent to the second section, and in which the start signal of the first voltage level is input, the first clock signal of the first voltage level is input, and the second clock signal of the second voltage level is input, the voltage of the first node and the voltage of the second node may be maintained at a third voltage level that is lower than the second voltage level, and the output signal of the second voltage level may be output from the output terminal by the fifth transistor that is turned on.

In an embodiment, in a fourth section subsequent to the third section, and in which the start signal of the first voltage level is input, the first clock signal of the first voltage level is input, and the second clock signal of the first voltage level is input, the voltage of the second node may be maintained at the second voltage level, the voltage of the first node may be a voltage level between the first voltage level and the second voltage level, and the output signal of the first voltage level may be output from the output terminal by the fifth transistor that is turned on.

In an embodiment, in a fifth section subsequent to the fourth section, and in which the start signal of the first voltage level is input, the first clock signal of the second voltage level is input, and the second clock signal of the first voltage level is input, the voltage of the first node and the voltage of the second node may be maintained at the first voltage level, and the output signal of the first voltage level may be output from the output terminal by the fourth transistor that is turned on.

In an embodiment, each of the plurality of stages may further include a sixth transistor connected between the second transistor and the second node and including a gate connected to a third terminal, to which a second voltage that is lower than the first voltage is applied, and a second capacitor connected between the second node and the output terminal.

In an embodiment, the first clock signal and the second clock signal may alternately repeat a first voltage level of the first voltage and a second voltage level of the second voltage, and the second clock signal is input by being shifted a ½ cycle from the first clock signal.

In an embodiment of the disclosure, a driving circuit includes a plurality of stages, wherein each of the plurality of stages may include a first transistor connected between a first node and a first terminal to which a start signal is input, and including a gate connected to a first clock terminal to which a first clock signal is input, a second transistor connected between the first node and a second node and including a gate connected to the first clock terminal, a third transistor connected between the first node and a second clock terminal to which a second clock signal is input, and including a gate connected to the first node, a first capacitor connected between the third transistor and the first node, a second capacitor connected between the second node and an output terminal, and a fourth transistor connected between the output terminal and the second clock terminal and including a gate connected to the second node, wherein the third transistor and the first capacitor change a voltage of the first node in synchronization with a voltage change of the second node.

In an embodiment, the start signal may include an external signal or an output signal output by a previous stage of each of the plurality of stages.

In an embodiment, the first clock signal and the second clock signal may alternately repeat a first voltage level and a second voltage level that is lower than the first voltage level, and the second clock signal is input by being shifted a ½ cycle from the first clock signal.

In an embodiment, each of the plurality of stages may further include a fifth transistor connected between a second terminal to which a first voltage of the first voltage level is applied, and the output terminal and including a gate connected to the first clock terminal, and a third capacitor connected between the second node and a third terminal, to which a second voltage of the second voltage level is applied.

In an embodiment, in a first section, in which the start signal of the second voltage level is input, the first clock signal of the second voltage level is input, and the second clock signal of the first voltage level is input, a voltage of the first node and a voltage of the second node may be maintained at the second voltage level, and an output signal of the first voltage level may be output from the output terminal by the fourth transistor and the fifth transistor that are turned on.

In an embodiment, in a second section subsequent to the first section, and in which the start signal of the first voltage level is input, the first clock signal of the first voltage level is input, and the second clock signal of the first voltage level is input, the voltage of the first node and the voltage of the second node may be maintained at the second voltage level, and the output signal of the first voltage level may be output from the output terminal by the fourth transistor that is turned on.

In an embodiment, in a third section subsequent to the second section, and in which the start signal of the first voltage level is input, the first clock signal of the first voltage level is input, and the second clock signal of the second voltage level is input, the voltage of the first node and the voltage of the second node may be maintained at a third voltage level that is lower than the second voltage level, and the output signal of the second voltage level may be output from the output terminal by the fourth transistor that is turned on.

In an embodiment, in a fourth section subsequent to the third section, in which the start signal of the first voltage level is input, the first clock signal of the first voltage level is input, and the second clock signal of the first voltage level is input, the voltage of the second node may be maintained at the second voltage level, the voltage of the first node may be a voltage level between the first voltage level and the second voltage level, and the output signal of the first voltage level may be output from the output terminal by the fourth transistor that is turned on.

In an embodiment, in a fifth section subsequent to the fourth section, and in which the start signal of the first voltage level is input, the first clock signal of the second voltage level is input, and the second clock signal of the first voltage level is input, the voltage of the first node and the voltage of the second node may be maintained at the first voltage level, and the output signal of the first voltage level may be output from the output terminal by the fifth transistor that is turned on.

### BRIEF DESCRIPTION OF THE DRAWINGS

The above and other features and advantages of illustrative embodiments of the disclosure will be more apparent from the following description taken in conjunction with the accompanying drawings, in which:

FIG. 1 is a schematic diagram schematically illustrating an embodiment of a driving circuit;

FIG. 2 is a timing diagram for schematically describing an embodiment of input/output signals of a driving circuit;

FIG. 3 is a circuit diagram schematically illustrating an embodiment of a stage in the driving circuit of FIG. 1;

FIG. 4 is a timing diagram for schematically describing the driving of the stage of FIG. 3;

FIG. 5 is a diagram showing voltages of a first node and a second node in some sections of FIG. 4;

FIG. 6 is a circuit diagram of an embodiment of the stage in the driving circuit of FIG. 1; and

FIG. 7 is a schematic block diagram of an embodiment of a display device.

### DETAILED DESCRIPTION

Reference will now be made in detail to embodiments, illustrative embodiments of which are illustrated in the accompanying drawings, wherein like reference numerals refer to like elements throughout. In this regard, the illustrated embodiments may have different forms and should not be construed as being limited to the descriptions set forth herein. Accordingly, the embodiments are merely described below, by referring to the drawing figures, to explain features of the description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Various modifications may be applied to the illustrated embodiments, and particular embodiments will be illustrated in the drawings and described in the detailed description section. The effect and features of the illustrated embodiments, and a method to achieve the same, will be clearer referring to the detailed descriptions below with the drawings. However, the illustrated embodiments may be implemented in various forms, not by being limited to the embodiments presented below.

In the following embodiment, it will be understood that although the terms “first,” “second,” etc. may be used herein to describe various elements, these elements should not be limited by these terms. These terms are only used to distinguish one element from another.

In the following embodiment, as used herein, the singular forms “a,” “an,” and “the” are intended to include the plural forms as well, unless the context clearly indicates otherwise.

In the following embodiment, it will be further understood that the terms “comprises” and/or “comprising” used herein specify the presence of stated features or elements, but do not preclude the presence or addition of one or more other features or elements.

Sizes of elements in the drawings may be exaggerated for convenience of explanation. For example, since sizes and thicknesses of elements in the drawings are arbitrarily illustrated for convenience of explanation, the following disclosure is not limited thereto.

In the specification, the expression such as “at least one of A and B” may include A, B, or A and B.

In the following embodiment, when X and Y are connected to each other, it may include a case in which X and Y are physically connected, a case in which X and Y are functionally connected, and a case in which X and Y are electrically connected. Furthermore, when X and Y are connected to each other, it may include a case in which X and Y are directly connected to each other and X and Y are indirectly connected to each other as another component is disposed therebetween. Here, X and Y may be objects, e.g., apparatuses, devices, circuits, wirings, electrodes, terminals, conductive films, layers, areas, etc.

For example, when X and Y are electrically connected to each other, it may include a case in which X and Y are directly electrically connected to each other and/or a case X and Y are indirectly electrically connected to each other as another component is disposed therebetween. When X and Y are indirectly electrically connected to each other, a component (e.g., switches, transistors, capacitors, inductors, resistors, diodes, etc.), which enable the electric connection between X and Y, is connected between X and Y. Accordingly, a certain connection relationship, for example, is not limited to the connection relationship described in the drawings or detailed descriptions, and may include things other than the connection relationship described in the drawings or detailed descriptions.

The term “ON” used in connection with a device state may refer to an activated state of the device, and the term “OFF” may refer to an inactive state of the device. The term “ON” used in connection with a signal received by a device may refer to a signal that activates the device, and the term “OFF” may refer to a signal that deactivates the device. A device may be activated by a high-level voltage having a relatively high voltage level (also referred to as a high level) or a low-level voltage having a relatively low voltage level (also referred to as a low level). In an embodiment, a P-channel transistor is activated by a low-level voltage, and an N-channel transistor is activated by a high-level voltage, for example. Accordingly, it should be understood that the “ON” voltages for a P-channel transistor and an N-channel transistor are at opposite (low vs. high) voltage levels. Hereinafter, a voltage to activate (turn on) a transistor is referred to as an on-voltage, and a voltage to deactivate (turn off) a transistor is referred to as an off-voltage.

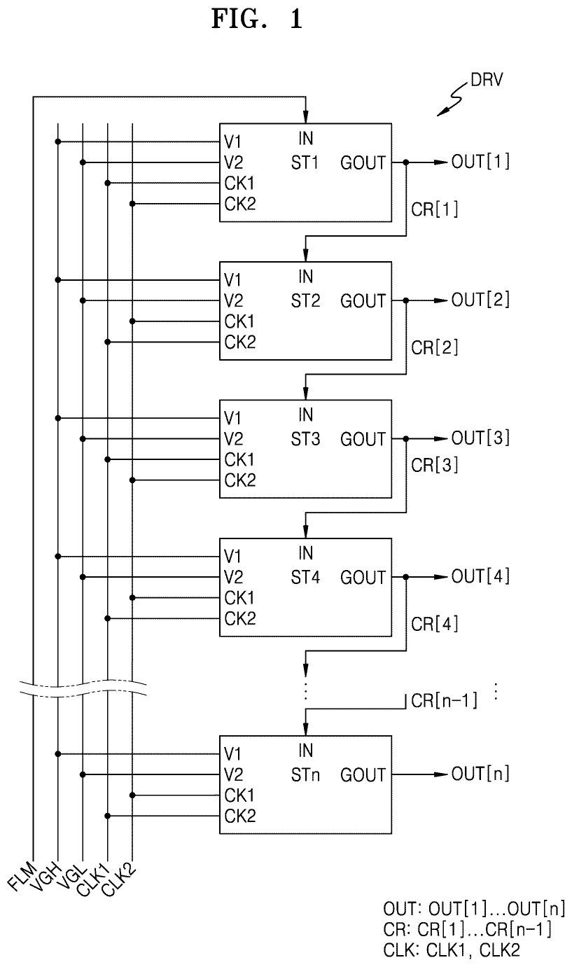

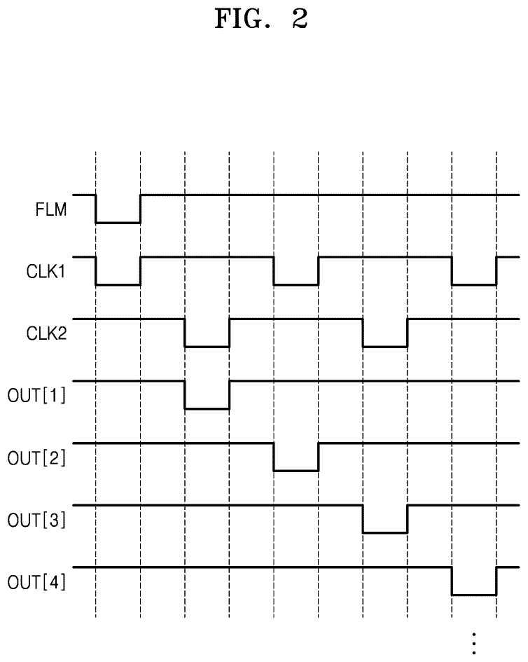

FIG. 1 is a schematic diagram schematically illustrating an embodiment of a driving circuit DRV. FIG. 2 is a timing diagram for schematically describing an embodiment of input/output signals of the driving circuit DRV.

Referring to FIG. 1, the driving circuit DRV in an embodiment may include a plurality of stages ST1 to STn. The stages ST1 to STn may sequentially output signals OUT[1], OUT[2], OUT[3], OUT[4], . . . , and OUT[n] to signal lines. Here, n may be a natural number greater than 0.

The stages ST1 to STn may each be connected to the signal line. The stages ST1 to STn may each receive at least one clock signal and at least one voltage signal, generate the output signal OUT, and output the generated signal to the signal line connected thereto. The stages ST1 to STn-1 may respectively generate carry signals CR (e.g., CR[1], CR[2], CR[3], CR[4], . . . , and CR[n-1]) and then output the generated signals to the subsequent stages. In an embodiment, the carry signals CR[1], CR[2], CR[3], CR[4], . . . , and CR[n-1] may be output signals (hereinafter, also referred to as ‘previous output signals’) output by the previous stages.

The stages ST1 to STn may respectively include a plurality of terminals, to or from which a plurality of signals is input or output. The plurality of signals may include a clock signal and a voltage signal. The plurality of terminals may include an input terminal IN, a first voltage input terminal V1, a second voltage input terminal V2, a first clock terminal CK1, a second clock terminal CK2, and an output terminal GOUT.

A start signal may be input (applied or provided) to the input terminal IN. The stages ST1 to STn may respectively output the output signals OUT[1], OUT[2], OUT[3], OUT[4], . . . , and OUT[n], in response to the start signal. The start signal may be an external signal FLM or the carry signals CR[1], CR[2], CR[3], CR[4], . . . , and CR[n-1]. The external signal FLM may be input, as the start signal, to the input terminal IN of the first stage ST1, and the previous output signals may be input, as the start signals, to the input terminals IN of the second to n-th stages ST2 to STn. The previous stage may be a stage disposed at least one before the current stage. FIG. 1 shows an embodiment in which the previous stage is a stage disposed immediately before the current stage. In an embodiment, the third output signal OUT[3] output from the third stage ST3 may be input to the input terminal IN of the fourth stage ST4, as the carry signal CR[3] and the start signal, for example.

A first voltage VGH may be input to the first voltage input terminal V1, and a second voltage VGL may be input to the second voltage input terminal V2. The second voltage VGL may be lower than the first voltage VGH. The voltage level of the second voltage VGL may be less than the voltage level of the first voltage VGH.

A clock signal CLK may be input to the first clock terminal CK1 and the second clock terminal CK2. The clock signal CLK may include a first clock signal CLK1 and a second clock signal CLK2. The first clock signal CLK1 or the second clock signal CLK2 may be input to the first clock terminal CK1 and the second clock terminal CK2. The first clock signal CLK1 and the second clock signal CLK2 may be alternately input to the first clock terminals CK1 of the stages ST1 to STn. The second clock signal CLK2 and the first clock signal CLK1 may be alternately input to the second clock terminals CK2 of the stages ST1 to STn.

In an embodiment, the first clock signal CLK1 and the second clock signal CLK2 may be respectively input to the first clock terminal CK1 and the second clock terminal CK2 of the odd-numbered stages ST1, ST3, . . . , etc. The second clock signal CLK2 and the first clock signal CLK1 may be respectively input to the first clock terminal CK1 and the second clock terminal CK2 of even-numbered stages ST2, ST4, . . . , etc. In an embodiment, the second clock signal CLK2 and the first clock signal CLK1 may be respectively input to the first clock terminal CK1 and the second clock terminal CK2 of the odd-numbered stages ST1, ST3, . . . , etc. The first clock signal CLK1 and the second clock signal CLK2 may be respectively input to the first clock terminal CK1 and the second clock terminal CK2 of the even-numbered stages ST2, ST4, . . . , etc.

As illustrated in FIG. 2, the first clock signal CLK1 and the second clock signal CLK2 may be square wave signals alternately repeating a relatively high voltage level (also referred to as first voltage level) and a relatively low voltage level (also referred to as a second voltage level). In an embodiment, the first clock signal CLK1 and the second clock signal CLK2 may be square wave signals repeating the first voltage VGH and the second voltage VGL. The first clock signal CLK1 and the second clock signal CLK2 may be signals having the same waveform and shifted phases as each other. In an embodiment, the second clock signal CLK2 has the same waveform as that of the first clock signal CLK1 and may be input with a phase shifted by a predetermined interval (phase delay), for example. The second clock signal CLK2 may be shifted a ½ cycle from the first clock signal CLK1. In an embodiment, a duration in which the first clock signal CLK1 and the second clock signal CLK2 are maintained at a relatively high voltage level and a duration in which the first clock signal CLK1 and the second clock signal CLK2 are maintained at a relatively low voltage level may be the same as each other in one cycle. In an embodiment, in one cycle, a duration in which the first clock signal CLK1 and the second clock signal CLK2 are maintained at a relatively high voltage level may be longer than a duration in which the first clock signal CLK1 and the second clock signal CLK2 are maintained at a relatively low voltage level.

The output signal may be output from the output terminal GOUT. As illustrated in FIG. 2, the output signals OUT[1], OUT[2], OUT[3], OUT[4], . . . , and OUT[n] output from the output terminal GOUT of the stages ST1 to STn may be sequentially shifted by a predetermined interval. In an embodiment, the stages ST1 to STn may sequentially output the output signals OUT[1], OUT[2], OUT[3], OUT[4], . . . , and OUT[n] of a high-level voltage to be shifted by a ½ cycle of the clock signal. In an embodiment, the high-level voltage and the low-level voltage of the output signals may be respectively the first voltage VGH and the second voltage VGL.

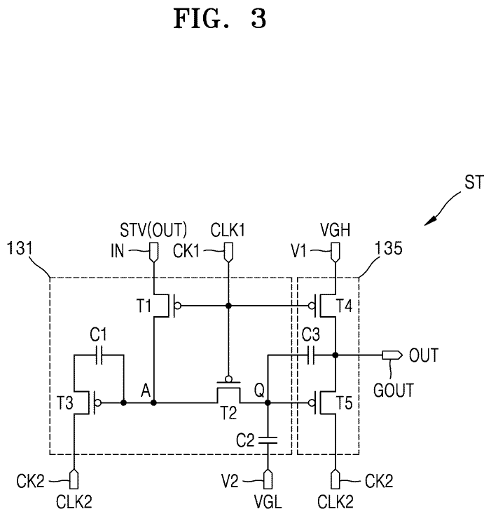

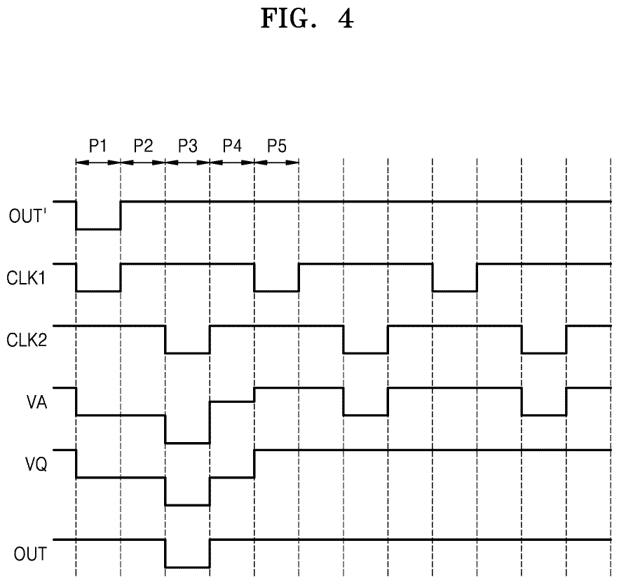

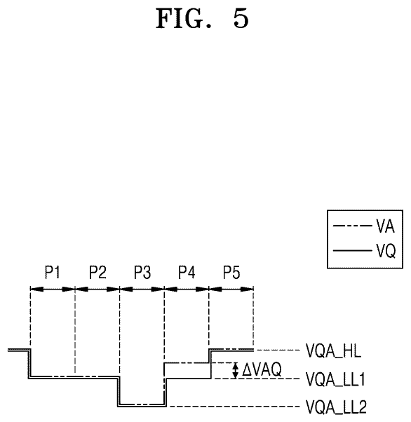

FIG. 3 is a circuit diagram schematically illustrating an embodiment of a stage ST in the driving circuit DRV of FIG. 1. FIG. 4 is a timing diagram for schematically describing the driving of the stage ST of FIG. 3. FIG. 5 is a diagram showing voltages of a first node and a second node in some sections of FIG. 4.

For convenience of explanation, it is described that the stage ST (current stage) of FIG. 3 is an odd-numbered stage, and that the first clock signal CLK1 is input to the first clock terminal CK1 and the second clock signal CLK2 is input to the second clock terminal CK2. The configuration and operation of an even-numbered stage are the same as the configuration and operation of an odd-numbered stage, except that, in the even-numbered stage, the second clock signal CLK2 is input to the first clock terminal CK1 and the first clock signal CLK1 is input to the second clock terminal CK2. The start signal of the first stage, that is, the first stage ST1, is the external signal FLM, and the start signals of the second and later stages may be previous output signals OUT′.

Referring to FIG. 3, the stage ST may include a control circuit 131 and an output circuit 135. The control circuit 131 and the output circuit 135 may each include at least one transistor. In an embodiment, the at least one transistor may be a P-channel transistor. The P-channel transistor may be a silicon transistor. The silicon transistor may include a silicon semiconductor, and the silicon semiconductor may include amorphous silicon, polysilicon, or the like. In an embodiment, the silicon transistor may be a low temperature polycrystalline silicon (“LTPS”) thin film transistor, for example. A gate-on voltage of the P-channel transistor may be a low-level voltage, and a gate-off voltage thereof may be a high-level voltage.

The control circuit 131 may control voltages of a first node A and a second node Q in response to a signal input to the input terminal IN. In an embodiment, the control circuit 131 may control the voltage VA of the first node A and the voltage VQ of the second node Q in response to a start signal STV, e.g., the external signal FLM or the carry signal CR of FIG. 1, for example. In an embodiment, the carry signal CR may be a previous output signal OUT′ of FIG. 4. The control circuit 131 may include first to third transistors T1 to T3. The control circuit 131 may include a first capacitor C1 and a second capacitor C2.

The first transistor T1 may be connected between the input terminal (also referred to as a first terminal) IN and the first node A. A gate of the first transistor T1 may be connected to the first clock terminal CK1. The first transistor T1 may be turned on when the first clock signal CLK1 input to the first clock terminal CK1 is a relatively low level and may transmit, to the first node A, the start signal STV input to the input terminal IN.

The second transistor T2 may be connected between the first node A and the second node Q. A gate of the second transistor T2 may be connected to the first clock terminal CK1. The second transistor T2 may be turned on when the first clock signal CLK1 input to the first clock terminal CK1 is a relatively low level and may transmit, to the second node Q, a signal transmitted to the first node A.

The third transistor T3 may be connected between the first node A and the second clock terminal CK2. The third transistor T3 may be connected between the first capacitor C1 and the second clock terminal CK2. A gate of the third transistor T3 may be connected to the first node A. The third transistor T3 may be turned on when the start signal STV transmitted to the first node A is a relatively low level, and a voltage of one end of the first capacitor C1 may be a voltage of the second clock signal CLK2 input to the second clock terminal CK2.

The first capacitor C1 may be connected between the third transistor T3 and the first node A. The one end of the first capacitor C1 may be connected to the third transistor T3, and an opposite end thereof may be connected to the first node A. The first capacitor C1 may prevent voltage fluctuations of the first node A.

The second capacitor C2 may be connected between the second node Q and the second voltage input terminal (also referred to as a third terminal) V2. One end of the second capacitor C2 may be connected to the second node Q, and an opposite end thereof may be connected to the second voltage input terminal V2. The second capacitor C2 may prevent voltage fluctuations of the second node Q.

The output circuit 135 may be connected between the first voltage input terminal V1 and the second clock terminal CK2. The output circuit 135 may include a fourth transistor T4 and a fifth transistor T5. The output circuit 135 may output the output signal OUT of a high-level voltage or a low-level voltage according to the voltage input to a gate of the fourth transistor T4 and the voltage input to a gate of the fifth transistor T5. The output circuit 135 may further include a third capacitor C3.

The fourth transistor T4 may be connected between the first voltage input terminal (also referred to as a second terminal) V1 and the output terminal GOUT. The gate of the fourth transistor T4 may be connected to the first clock terminal CK1. The fourth transistor T4 may be a pull-up transistor that transmits a high-level voltage to the output terminal GOUT. The fourth transistor T4 may be turned on when the first clock signal CLK1 input to the first clock terminal CK1 has a relatively low level and may transmit, to the output terminal GOUT, the first voltage VGH of a high-level voltage input to the first voltage input terminal V1.

The fifth transistor T5 may be connected between the output terminal GOUT and the second clock terminal CK2. The gate of the fifth transistor T5 may be connected to the second node Q. The fifth transistor T5 may be a pull-down transistor that transmits a low-level voltage to the output terminal GOUT. The fifth transistor T5 may be turned on when the voltage of the second node Q is a relatively low level and may transmit, to the output terminal GOUT, the second clock signal CLK2 input to the second clock terminal CK2.

The third capacitor C3 may be connected between the output terminal GOUT and the second node Q. The third capacitor C3 may be a bootstrap capacitor that changes the voltage of the second node Q in conjunction with a voltage change of the output terminal GOUT when the second transistor T2 is turned off.

Hereinafter, the operation of the stage illustrated in FIG. 3 is described with reference to FIG. 4. FIG. 4 is a timing diagram of an embodiment in which the stage ST of FIG. 3 is an arbitrary stage of the odd-numbered stages after the second stage.

In a first section P1, the previous output signal OUT′ of a relatively low level may be input to the input terminal IN, the first clock signal CLK1 of a relatively low level may be input to the first clock terminal CK1, and the second clock signal CLK2 of a relatively high level may be input to the second clock terminal CK2.

The first transistor T1, the second transistor T2, and the fourth transistor T4 may be turned on by first clock signal CLK1 of a relatively low level.

The previous output signal OUT′ of a relatively low level may be transmitted, to the first node A and the second node Q, by the first transistor T1 and the second transistor T2 that are turned on, and the voltage VA of the first node A and the voltage VQ of the second node Q may be maintained at a relatively low voltage level. A relatively low voltage level VQA_LL1 (refer to FIG. 5) of the voltage VA of the first node A and the voltage VQ of the second node Q may be approximately a relatively low voltage level of the previous output signal OUT′. In an embodiment, the relatively low voltage level VQA_LL1 of the voltage VA of the first node A and the voltage VQ of the second node Q may be a higher voltage level than a relatively low voltage level of the previous output signal OUT′ due to threshold voltage loss of the first transistor T1 and the second transistor T2 in the previous output signal OUT′.

The fifth transistor T5 with the gate connected to the second node Q may be turned on, and the second clock signal CLK2 of a relatively high level may be transmitted to the output terminal GOUT. The first voltage VGH of a relatively high level may be transmitted, to the output terminal GOUT, by the fourth transistor T4 that is turned on. Accordingly, the output signal OUT of a relatively high level may be output from the output terminal GOUT. A difference between the voltage of the output terminal GOUT and the voltage of the second voltage input terminal V2 may be stored in the second capacitor C2 and the third capacitor C3 according to a voltage distribution. Herein, the expression “storing . . . voltage/voltage difference” with respect to a capacitor means that the capacitor stores charges corresponding to the voltage/voltage difference.

The third transistor T3 with the gate connected to the first node A may be turned on, and the voltage of the one end of the first capacitor C1 may have a relatively high voltage level of the second clock signal CLK2 transmitted through the third transistor T3. A difference between a voltage level of the voltage VA of the first node A and the relatively high voltage level of the second clock signal CLK2 may be stored in the first capacitor C1.

As illustrated in FIG. 5, in the first section P1, the voltage change amount of the first node A may be approximately the same as the voltage change amount of the second node Q, and a difference between the voltage VA of the first node A and the voltage VQ of the second node Q may be about 0 V.

In a second section P2, the previous output signal OUT′ of a relatively high level may be input to the input terminal IN, the first clock signal CLK1 of a relatively high level may be input to the first clock terminal CK1, and the second clock signal CLK2 of a relatively high level may be input to the second clock terminal CK2.

The first transistor T1, the second transistor T2, and the fourth transistor T4 may be turned off by the first clock signal CLK1 of a relatively high level. The voltage of the second node Q may be maintained at a relatively low voltage level in the first section P1 by the second capacitor C2 and the third capacitor C3. The fifth transistor T5 with the gate connected to the second node Q may maintain a turn-on state, and the second clock signal CLK2 of a relatively high level may be transmitted to the output terminal GOUT. Accordingly, the second clock signal CLK2 of a relatively high level may be output the output terminal GOUT as the output signal OUT.

The voltage of the first node A may be maintained at a relatively low voltage level by the first capacitor C1 in the first section P1, and the third transistor T3 with the gate connected to the first node A may maintain a turn-on state. The voltage of the one end of the first capacitor C1 may be maintained at a relatively high level.

As illustrated in FIG. 5, in the second section P2, the voltage change amount of the first node A may be approximately the same as the voltage change amount of the second node Q, and a difference between the voltage of the voltage VA of the first node A and the voltage VQ of the second node Q may be about 0 V.

In a third section P3, the previous output signal OUT′ of a relatively high level may be input to the input terminal IN, the first clock signal CLK1 of a relatively high level may be input to the first clock terminal CK1, and the second clock signal CLK2 of a relatively low level may be input to the second clock terminal CK2.

As the first clock signal CLK1 is maintained at a relatively high level, the first transistor T1, the second transistor T2, and the fourth transistor T4 may maintain a turn-off state. The voltage of the second node Q may be maintained at a relatively low voltage level in the second section P2 by the second capacitor C2 and the third capacitor C3. The second clock signal CLK2 of a relatively low level is transmitted to the output terminal GOUT by the fifth transistor T5 that is turned on, and the second clock signal CLK2 of a relatively low level may be output, as the output signal OUT, from the output terminal GOUT. In this state, as the voltage of the output terminal GOUT drops from a relatively high level to a relatively low level, due to the coupling of the third capacitor C3, the voltage of the second node Q may be dropped to a relatively low voltage level (also referred to as a third voltage level) VQA_LL2 of FIG. 5 that is lower than the relatively low voltage level VQA_LL1 in the second section P2.

The voltage of the first node A may be maintained at the relatively low voltage level in the second section P2 by the first capacitor C1. The second clock signal CLK2 of a relatively low level is transmitted to the one end of the first capacitor C1 by the third transistor T3 that is turned on, and as the voltage of the one end of the first capacitor C1 is dropped from a relatively high level to a relatively low level, due to the coupling of the first capacitor C1, the voltage of the first node A may be dropped to the relatively low voltage level VQA_LL2 of FIG. 5 that is lower than the relatively low voltage level VQA_LL1 in the second section P2.

As illustrated in FIG. 5, in the third section P3, the voltage change amount of the first node A may be approximately the same as the voltage change amount of the second node Q, and in the third section P3, the difference between the voltage of the voltage VA of the first node A and the voltage VQ of the second node Q may be about 0 V.

In a fourth section P4, the previous output signal OUT′ of a relatively high level may be input to the input terminal IN, the first clock signal CLK1 of a relatively high level may be input to the first clock terminal CK1, and the second clock signal CLK2 of a relatively high level may be input to the second clock terminal CK2.

As the first clock signal CLK1 maintains a relatively high level, the first transistor T1, the second transistor T2, and the fourth transistor T4 may maintain a turn-off state.

The voltage of the first node A may be maintained at the relatively low voltage level in the third section P3 by the first capacitor C1. The second clock signal CLK2 of a relatively high level is transmitted to the one end of the first capacitor C1 by the third transistor T3 that is turned on, and as the voltage of the one end of the first capacitor C1 increases from a relatively low level to a relatively high level, due to the coupling of the first capacitor C1, the voltage of the first node A may rise to a relatively low voltage level that is higher than the relatively low voltage level in the third section P3.

The voltage of the second node Q may be maintained at the relatively low voltage level in the third section P3 by the second capacitor C2 and the third capacitor C3. The second clock signal CLK2 of a relatively high level may be transmitted to the output terminal GOUT by the fifth transistor T5 that is turned on, and the second clock signal CLK2 of a relatively high level may be output, as the output signal OUT, from the output terminal GOUT. In this state, as the voltage of the output terminal GOUT rises from a relatively low level to a relatively high level, due to the coupling of the third capacitor C3, the voltage of the second node Q may rise to a relatively low voltage level higher than the relatively low voltage level in the third section P3. In this state, due to the voltage distribution of the second capacitor C2 and the third capacitor C3, the voltage of the second node Q may be lower than the voltage of the first node A.

As illustrated in FIG. 5, in the fourth section P4, the voltage change amount of the second node Q may be less than the voltage change amount of the first node A, and the voltage of the first node A may be higher than the voltage of the second node Q. In the fourth section P4, a voltage difference AVAQ between the voltage VA of the first node A and the voltage VQ of the second node Q may be less than a difference between a relatively high voltage level VQA_HL and the relatively low voltage level VQA_LL1 of the voltage VA of the first node A and the voltage VQ of the second node Q and a difference between the relatively low voltage level VQA_LL1 and the relatively low voltage level VQA_LL2 of the voltage VA of the first node A and the voltage VQ of the second node Q.

In a fifth section P5, the previous output signal OUT′ of a relatively high level may be input to the input terminal IN, the first clock signal CLK1 of a relatively low level may be input to the first clock terminal CK1, and the second clock signal CLK2 of a relatively high level may be input to the second clock terminal CK2.

The first transistor T1, the second transistor T2, and the fourth transistor T4 may be turned on by first clock signal CLK1 of a relatively low level.

The previous output signal OUT′ of a relatively high level may be transmitted to the first node A and the second node Q by the first transistor T1 and the second transistor T2 that are turned on, and the voltage VA of the first node A and the voltage VQ of the second node Q may be maintained at the relatively high voltage level VQA_HL. The third transistor T3 with the gate connected to the first node A may be turned off, and the fifth transistor T5 with the gate connected to the second node Q may be turned off.

The first voltage VGH of a relatively high level may be transmitted to the output terminal GOUT by the fourth transistor T4 that is turned on, and the first voltage VGH of a relatively high level may be output, as the output signal OUT, from the output terminal GOUT. The difference between the voltage of the output terminal GOUT and the voltage of the second voltage input terminal V2 may be stored in the second capacitor C2 and the third capacitor C3 according to the voltage distribution.

As illustrated in FIG. 5, in the fifth section P5, the voltage change amount of the first node A and the voltage change amount of the second node Q may be approximately the same as each other, and the difference between the voltage of the voltage VA of the first node A and the voltage VQ of the second node Q may be about 0 V.

By embodiments, as the third transistor T3 and the first capacitor C1 are connected to the first node A, in a duration in which the second node Q is a relatively low level, by performing a multilevel change of the voltage of the first node A in conjunction with a multilevel change of the voltage of the second node Q, a voltage difference between opposite ends of the second transistor T2 connected to the second node Q may be minimized. Accordingly, stress of the second transistor T2 may be reduced, and shaking and a leakage current of the first node A and the second node Q may be minimized or prevented.

The voltage of the second node Q may be a relatively high level until a start signal of a subsequent frame is input after the fifth section P5. After the fifth section P5, when a first clock signal CLK1 is a relatively low level and the second clock signal CLK2 is a relatively high level, the voltage VA of the first node A and the voltage VQ of the second node Q may be a relatively high level of the previous output signal OUT′ by the first transistor T1 and the second transistor T2 that are turned on. When the first clock signal CLK1 has a relatively high level and the second clock signal CLK2 has a relatively high level, the voltage VA of the first node A and the voltage VQ of the second node Q may be maintained at a relatively high level by the first capacitor C1, the second capacitor C2, and the third capacitor C3. When the first clock signal CLK1 is a relatively high level and the second clock signal CLK2 is a relatively low level, the voltage of the second node Q may be maintained at a relatively high level by the second capacitor C2 and the third capacitor C3, and the voltage of the first node A may be dropped by a leakage current of the third transistor T3.

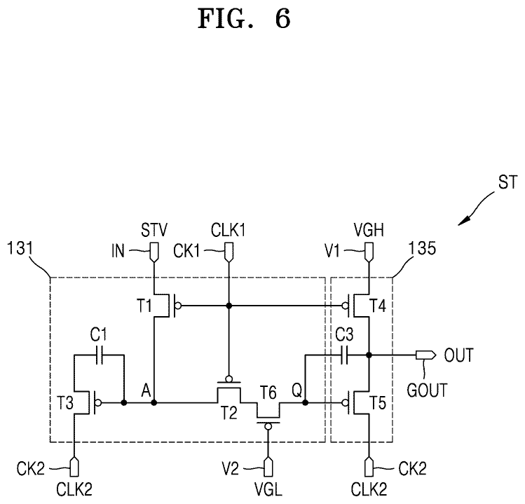

FIG. 6 is a circuit diagram of an embodiment of the stage ST in the driving circuit DRV of FIG. 1. Hereinafter, differences from the stage ST illustrated in FIG. 3 are mainly described.

The stage ST illustrated in FIG. 6 differs from the stage ST illustrated in FIG. 3 in that the second capacitor C2 is omitted and a sixth transistor T6 is provided, and another configuration and operation are the same as the configuration and operation of the stage ST illustrated in FIG. 3.

The sixth transistor T6 may be connected between the second transistor T2 and the second node Q. A gate of the sixth transistor T6 may be connected to the second voltage input terminal V2. The sixth transistor T6 may be turned on by the second voltage VGL input to the second voltage input terminal V2, and may transmit, to the second node Q, a start signal transmitted through the second transistor T2. The sixth transistor T6 may always be in a turn-on state. The sixth transistor T6 may reduce the stress of the second transistor T2 by sharing stress by the multilevel change of the voltage of the second node Q, with the second transistor T2.

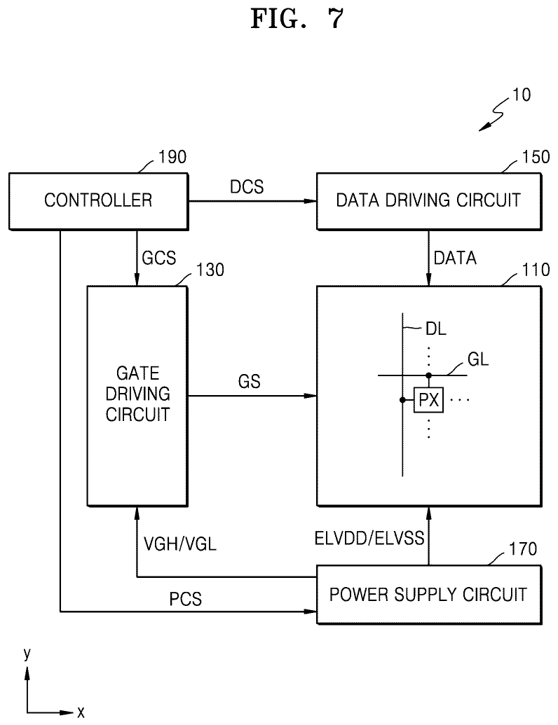

FIG. 7 is a schematic block diagram of an embodiment of a display device 10.

In an embodiment, the display device 10 may include, e.g., an organic light-emitting display device, an inorganic light-emitting display device (or an inorganic electroluminescent (“EL”) display device), and a quantum-dot light-emitting display device.

Referring to FIG. 7, the display device 10 in an embodiment may include a pixel area 110, a gate driving circuit 130, a data driving circuit 150, a power supply circuit 170, and a controller 190.

The pixel area 110 may correspond to a display area that displays an image. Various wirings for transmitting electrical signals to be applied to the display area, outside driving circuits electrically connected to pixel circuits, pads to which a printed circuit board or a driver integrated circuit (“IC”) chip is attached, or the like may be disposed in a peripheral area (non-display area) outside the display area. In an embodiment, the gate driving circuit 130, the data driving circuit 150, the power supply circuit 170, and the controller 190 may be provided in the peripheral area, for example.

A plurality of gate lines GL, a plurality of data lines DL, and a plurality of pixels PX connected to the gate lines GL and the data lines DL may be disposed in the pixel area 110. The pixels PX may be repeatedly arranged in a first direction (an x-direction or a row direction) and a second direction (a y-direction or a column direction). The pixels PX may be arranged in various forms, such as a stripe array, a PENTILE® array, a diamond array, a mosaic array, or the like, and may implement an image. Each of the pixels PX may include an organic light-emitting diode (“OLED”) as a display element, and the OLED may be connected to the pixel circuit. The pixel circuit may include a plurality of transistors and at least one capacitor. Each pixel PX may emit, e.g., red, green, blue, or white light, through the OLED. Each pixel PX may be connected to a corresponding gate line of the gate lines GL and a corresponding data line of the data lines DL.

In an embodiment, a plurality of transistors in the pixel area 110 may be a P-channel transistors (P-channel silicon transistor). In an embodiment, a plurality of transistors in the pixel circuit may be an N-channel transistors (N-channel oxide transistor). In an embodiment, some transistors in the pixel circuit may be P-channel silicon transistor, and some other transistors may be an N-channel oxide transistor.

The gate lines GL may each extend in the x direction (row direction) to be connected to the pixels PX disposed in the same row. The gate lines GL may each transmit a gate signal to the pixels PX in the same row. The data lines DL may each extend in the y direction (column direction) to be connected to the pixels PX disposed in the same column. The data lines DL, in synchronization with a gate signal, may each transmit a data signal to the pixels PX in the same column.

The gate driving circuit 130 may be connected to the gate lines GL and may generate a gate signal GS, in response to a gate driving control signal GCS from the controller 190 and sequentially apply the gate signal GS to the gate lines GL. The gate line GL may be connected to a gate of the transistor in the pixel PX, and the gate signal GS may be a gate control signal to control turning on and off of the transistor, to which the gate line GL is connected. The gate signal GS may include a gate-on voltage to turn on the transistor and a gate-off voltage to turn off the transistor. The gate driving circuit 130 may include a plurality of stages to sequentially generate and output the gate signal GS.

In an embodiment, the gate driving circuit 130 may be implemented as the driving circuit DRV including the stage ST illustrated in FIG. 3 or 6. In an embodiment, the gate signal GS output by the gate driving circuit 130 to each gate line GL may correspond to the output signal OUT of a relatively low level output by each of the stages ST1 to STn of the driving circuit DRV to the signal line, for example. Each of the stages ST1 to STn may be connected to a gate line disposed in a corresponding row of the pixel area 110. Each of the stages ST1 to STn may generate the gate signal GS and output the generated gate signal GS to the gate line GL connected thereto. In other words, each of the stages ST1 to STn may apply the gate signal GS of a relatively low level to the gate line GL in a corresponding row. In an embodiment, each of the stages ST1 to STn of the gate driving circuit 130 may include the third transistor T3 and the first capacitor C1 described above.

The number of stages constituting the gate driving circuit 130, to which the driving circuit DRV in an embodiment is applied, may be variously changed depending on the number of rows (horizontal line) provided in the pixel area 110.

The data driving circuit 150 may be connected to the data lines DL and may apply a data signal DATA to the data lines DL in response to a data driving control signal DCS from the controller 190. The data signal DATA applied to the data lines DL may be applied to the pixels PX, to which the gate signal is applied. The data driving circuit 150 may convert input image data having gradation and input from the controller 190 into the data signal DATA in the form of a voltage or current.

The power supply circuit 170 may generate signals (voltage and current) desired for driving of the pixels PX of the pixel area 110, in response to a power driving control signal PCS from the controller 190. When the display device 10 is an organic light-emitting display device, the power supply circuit 170 may generate a first power voltage ELVDD and a second power voltage ELVSS and apply the generated voltages to the pixels PX. The first power voltage ELVDD may be a high-level voltage applied to one terminal of a driving transistor connected to a first electrode (pixel electrode or anode) of the OLED of each pixel PX. The second power voltage ELVSS may be a low-level voltage applied to a second electrode (counter electrode or cathode) of the OLED. The first power voltage ELVDD and the second power voltage ELVSS may be a driving voltage to allow the pixels PX to emit light.

The power supply circuit 170 may generate the first voltage VGH and the second voltage VGL and apply the generated voltages to the gate driving circuit 130. The power supply circuit 170 may generate the clock signals CLK1 and CLK2 of FIG. 1 and the external signal FLM of FIG. 1 and apply the generated signals to the gate driving circuit 130.

The controller 190 may generate the gate driving control signal GCS, the data driving control signal DCS, and the power driving control signal PCS, based on externally input signals. The controller 190 may apply the gate driving control signal GCS to the gate driving circuit 130, the data driving control signal DCS to the data driving circuit 150, and the power driving control signal PCS to the power supply circuit 170.

Although the display device 10 of FIG. 7 independently includes the power supply circuit 170 and the controller 190, the disclosure is not limited thereto. In an embodiment, the power supply circuit 170 may be included in the controller 190.

The display device 10 may include a display panel, and the display panel may include a substrate. The pixels PX may be disposed in the display area of the substrate. A part or the whole of the gate driving circuit 130 may be directly formed in the peripheral area of the substrate in a process of forming a transistor constituting the pixel circuit in the display area of the substrate. The data driving circuit 150, the power supply circuit 170, and the controller 190 may each be formed in the form of separate integrated circuit chips or one integrated circuit chip to be disposed on a flexible printed circuit board (“FPCB”) electrically connected to the pad disposed at one side of the substrate. In another embodiment, the data driving circuit 150, the power supply circuit 170, and the controller 190 may be disposed directly on the substrate in a chip-on-glass (“COG”) or chip-on-plastic (“COP”) method.

By embodiments, by forming a driving circuit with a relatively small number of transistors and capacitors, dead space may be minimized, and a driving circuit capable of stably outputting a gate signal and a display device including the driving circuit may be provided.

By embodiments, with a relatively small number of circuit devices, the size of a non-display area may be reduced, and a driving circuit capable of stably outputting a gate signal and a display device including the driving circuit may be provided. The effects of the disclosure are not limited to the effects described above, and may be variously expanded within the scope of the disclosure.

It should be understood that embodiments described herein should be considered in a descriptive sense only and not for purposes of limitation. Descriptions of features or advantages within each embodiment should typically be considered as available for other similar features or advantages in other embodiments. While embodiments have been described with reference to the drawing figures, it will be understood by those of ordinary skill in the art that various changes in form and details may be made therein without departing from the spirit and scope as defined by the following claims.

What is claimed is:

1. A driving circuit comprising a plurality of stages, each of the plurality of stages comprising:
a first transistor connected between a first node and a first terminal to which a start signal is input, the first transistor comprising:
a gate connected to a first clock terminal to which a first clock signal is input;
a second transistor connected between the first node and a second node, the second transistor comprising:
a gate connected to the first clock terminal;
a third transistor connected between the first node and a second clock terminal to which a second clock signal is input, the third transistor comprising:
a gate connected to the first node;
a first capacitor connected between the third transistor and the first node;
a fourth transistor connected between an output terminal and a second terminal to which a first voltage is applied, the fourth transistor comprising:
a gate connected to the first clock terminal; and
a fifth transistor connected between the output terminal and the second clock terminal, the fifth transistor comprising:
a gate connected to the second node.

2. The driving circuit of claim 1, wherein the start signal comprises an external signal or an output signal output by a previous stage of each of the plurality of stages.

3. The driving circuit of claim 1, wherein each of the plurality of stages further comprises:
a second capacitor connected between the second node and a third terminal to which a second voltage which is lower than the first voltage is applied; and
a third capacitor connected between the second node and the output terminal.

4. The driving circuit of claim 3, wherein the first clock signal and the second clock signal alternately repeat a first voltage level of the first voltage and a second voltage level of the second voltage, and
the second clock signal is input by being shifted a ½ cycle from the first clock signal.

5. The driving circuit of claim 4, wherein, in a first section, in which the start signal of the second voltage level is input, the first clock signal of the second voltage level is input, and the second clock signal of the first voltage level is input,
a voltage of the first node and a voltage of the second node are maintained at the second voltage level, and
an output signal of the first voltage level is output from the output terminal by the fourth transistor which is turned on and the fifth transistor which is turned on.

6. The driving circuit of claim 5, wherein, in a second section subsequent to the first section, and in which the start signal of the first voltage level is input, the first clock signal of the first voltage level is input, and the second clock signal of the first voltage level is input,
the voltage of the first node and the voltage of the second node are maintained at the second voltage level, and
the output signal of the first voltage level is output from the output terminal by the fifth transistor which is turned on.

7. The driving circuit of claim 6, wherein, in a third section subsequent to the second section, and in which the start signal of the first voltage level is input, the first clock signal of the first voltage level is input, and the second clock signal of the second voltage level is input,
the voltage of the first node and the voltage of the second node are maintained at a third voltage level which is lower than the second voltage level, and
the output signal of the second voltage level is output from the output terminal by the fifth transistor which is turned on.

8. The driving circuit of claim 7, wherein, in a fourth section subsequent to the third section, and in which the start signal of the first voltage level is input, the first clock signal of the first voltage level is input, and the second clock signal of the first voltage level is input,
the voltage of the second node is maintained at the second voltage level,
the voltage of the first node is maintained at a voltage level between the first voltage level and the second voltage level, and
the output signal of the first voltage level is output from the output terminal by the fifth transistor which is turned on.

9. The driving circuit of claim 8, wherein, in a fifth section subsequent to the fourth section, and in which the start signal of the first voltage level is input, the first clock signal of the second voltage level is input, and the second clock signal of the first voltage level is input,
the voltage of the first node and the voltage of the second node are maintained at the first voltage level, and
the output signal of the first voltage level is output from the output terminal by the fourth transistor which is turned on.

10. The driving circuit of claim 1, wherein each of the plurality of stages further comprises:
a sixth transistor connected between the second transistor and the second node and comprising a gate connected to a third terminal, to which a second voltage which is lower than the first voltage is applied; and
a second capacitor connected between the second node and the output terminal.

11. The driving circuit of claim 10, wherein the first clock signal and the second clock signal alternately repeat a first voltage level of the first voltage and a second voltage level of the second voltage, and
the second clock signal is input by being shifted a ½ cycle from the first clock signal.

12. A driving circuit comprising a plurality of stages, each of the plurality of stages comprising:
a first transistor connected between a first node and a first terminal to which a start signal is input, the first transistor comprising:
a gate connected to a first clock terminal to which a first clock signal is input;
a second transistor connected between the first node and a second node, the second transistor comprising:
a gate connected to the first clock terminal;
a third transistor connected between the first node and a second clock terminal to which a second clock signal is input, the third transistor comprising:
a gate connected to the first node;
a first capacitor connected between the third transistor and the first node;
a second capacitor connected between the second node and an output terminal; and
a fourth transistor connected between the output terminal and the second clock terminal, the fourth transistor comprising:
a gate connected to the second node, and
wherein the third transistor and the first capacitor change a voltage of the first node in synchronization with a voltage change of the second node.

13. The driving circuit of claim 12, wherein the start signal comprises an external signal or an output signal output by a previous stage of each of the plurality of stages.

14. The driving circuit of claim 12, wherein the first clock signal and the second clock signal alternately repeat a first voltage level and a second voltage level which is lower than the first voltage level, and
the second clock signal is input by being shifted a ½ cycle from the first clock signal.

15. The driving circuit of claim 14, wherein each of the plurality of stages further comprises:
a fifth transistor connected between the output terminal and a second terminal to which a first voltage of the first voltage level is applied, and comprising a gate connected to the first clock terminal; and
a third capacitor connected between the second node and a third terminal to which a second voltage of the second voltage level is applied.

16. The driving circuit of claim 15, wherein, in a first section, in which the start signal of the second voltage level is input, the first clock signal of the second voltage level is input, and the second clock signal of the first voltage level is input,
a voltage of the first node and a voltage of the second node are maintained at the second voltage level, and
an output signal of the first voltage level is output from the output terminal by the fourth transistor and the fifth transistor which are turned on.

17. The driving circuit of claim 16, wherein, in a second section subsequent to the first section, and in which the start signal of the first voltage level is input, the first clock signal of the first voltage level is input, and the second clock signal of the first voltage level is input,
the voltage of the first node and the voltage of the second node are maintained at the second voltage level, and
the output signal of the first voltage level is output from the output terminal by the fourth transistor which is turned on.

18. The driving circuit of claim 17, wherein, in a third section subsequent to the second section, and in which the start signal of the first voltage level is input, the first clock signal of the first voltage level is input, and the second clock signal of the second voltage level is input,
the voltage of the first node and the voltage of the second node are maintained at a third voltage level which is lower than the second voltage level, and
the output signal of the second voltage level is output from the output terminal by the fourth transistor which is turned on.

19. The driving circuit of claim 18, wherein, in a fourth section subsequent to the third section, in which the start signal of the first voltage level is input, the first clock signal of the first voltage level is input, and the second clock signal of the first voltage level is input,
the voltage of the second node is maintained at the second voltage level,
the voltage of the first node is maintained at a voltage level between the first voltage level and the second voltage level, and
the output signal of the first voltage level is output from the output terminal by the fourth transistor which is turned on.

20. The driving circuit of claim 19, wherein, in a fifth section subsequent to the fourth section, and in which the start signal of the first voltage level is input, the first clock signal of the second voltage level is input, and the second clock signal of the first voltage level is input,
the voltage of the first node and the voltage of the second node are maintained at the first voltage level, and
the output signal of the first voltage level is output from the output terminal by the fifth transistor which is turned on.
